(19) United States
(12) Patent Application Publication
(10) Pub. No.: US 2009/0022654 A1
(43) Pub. Date: Jan. 22, 2009

(54) Method for reforming hydrocarbon gas by oxyhydrogen flame and apparatus for reforming hydrocarbon gas

(75) Inventor: Tomoki Yamasaki, (US)

Correspondence Address: BIRCH STEWART KOLASCH & BIRCH, PO BOX 747, FALLS CHURCH, VA, 22040-0747, US

(73) Assignee: Japan Hydrogen Co. Ltd.

(21) Appl. No.: 11/892,386

(22) Filed: Aug. 22, 2007

(30) Foreign Application Priority Data
Jul. 18, 2007 (JP) 2007-186909

(51) Int. Cl. C01B 3/26; B01J 19/00

(52) U.S. Cl. 423/651; 422/212

(57) ABSTRACT

An objective is to reform, separate, and extract from a hydrocarbon gas such as methane, ethane, and propane.

A method for reforming hydrocarbon gas by oxyhydrogen flame is that hydrogen and carbon are separated from hydrocarbon gas by accommodating a catalyst composed of nickel, platinum, palladium, and carbon in a reformation column surrounded with insulation, directly heating the catalyst to 400 to 650° C. by oxyhydrogen flame, flowing hydrocarbon gas into the inside of the reformation column, and contacting hydrocarbon gas with the heated catalyst, and hydrogen is obtained by cooling the hydrogen.

### BACKGROUND OF THE INVENTION

The present invention relates to a method for reforming hydrocarbon gas by oxyhydrogen flame in which hydrogen is reformed, separated, and extracted from a hydrocarbon gas such as methane, ethane, and propane, and to an apparatus for reforming hydrocarbon gas.

It is known that when hydrocarbon gas is set to a high temperature of 170° C. or more, the bonding of a carbon atom and a hydrogen atom loosens, it proceeds to a weaker molecular bonding, and it finally becomes carbon and hydrogen. This method is important because it is the only method without forming carbon dioxide as a by-product for reforming hydrocarbon gas.

However, a high temperature is necessary for reforming in this method. This thermal decomposition method of hydrocarbon gas is not adopted because the fuel is not balanced if a reformation column is heated from the outside, a large amount of carbon dioxide is generated by using a fossil fuel, and it is not worth considering because carbon dioxide is generated in the essential production of hydrogen by uses of hydrogen combustion and hydrogen-fuel cells even with an effort to contribute to cleaning up the global environment.

However, the heat balance of methane among the hydrocarbon gas is as follows.

(1) CH₄→C+2H₂ −74.9 KJ

(2) CH₄+2O₂→CO₂+2H₂O +840.2 KJ

(3) C+O₂→CO₂ +393.5 KJ

(4) 2H₂+O₂→2H₂O +571.6 KJ

Therefore, the endotherm for the decomposition of methane becomes 74.9 KJ, the exotherm of the decomposed hydrogen becomes 571.6 KJ, and (4)−(1) becomes +496.7 KJ. It is possible to extract hydrogen from methane and to use it depending on the heat balance of the reformation column.

The problem is the heat balance of the reformation column.

The thermal decomposition of methane is not realized because the total amount of loss of the methane decomposition described in (1) in an endothermic reaction, the amount of heat required to bring the raw material methane to the decomposition temperature and to maintain it, the heat loss that the reformation column has, etc. become a burden of fuel when heating.

The heating temperature that is necessary in the thermal decomposition process of methane is generally considered to be 700 to 1000° C. However, it is important for this temperature to be lower in order to determine the material of the reformation column and the heating method, and especially in order to decrease the heat loss, thermal decomposition at a lower temperature is necessary and a catalyst that can handle such cases is necessary (Japanese Patent Application Laid-Open No. 2002-321904).

A reformation temperature with high heat is necessary in order to obtain hydrogen from a hydrocarbon gas such as methane, ethane, and propane. The cost of the fuel and the yield of hydrogen for that are problems, and the industrial cost is not paid off. Therefore, it has been never provided for general use.

In view of the above-described circumstances, oxyhydrogen flame is directly blown into the inside of the reformation column surrounded with insulation, and hydrocarbon gas is sent into it in the present invention. A mixed material of nickel, platinum, and carbon is used as a catalyst to lower the thermal decomposition temperature, and the sending amount of hydrocarbon gas and intensity of oxyhydrogen flame are adjusted with an inside column temperature regulator so as to keep the inside of the reformation column at 400 to 650° C.

CH₄→C+2H₂

The carbon generated by the above equation is released in a carbon precipitate tank connecting straight down from the reformation column by a vibration apparatus and a stream of hydrogen so that the carbon is not entwined around the catalyst.

The generated hydrogen is cooled, refined, and compressed and inserted into a tank. A part of the crude hydrogen is used for the oxyhydrogen flame.

To prevent heat from escaping by electric heat and radiation heat, using various materials becomes an important factor of heat balance of the reformation column for the insulation surrounding the reformation column.

It is important in the heat balance of the reformation column to recover thermal energy that the generated hydrogen has with a heat exchanger and to use it in preheating hydrocarbon gas.

The present invention is a method for reforming hydrocarbon gas by oxyhydrogen flame in which hydrogen and carbon are separated from hydrocarbon gas by accommodating a catalyst consisting of nickel, platinum, palladium, and carbon in a reformation column surrounded with insulation, directly heating the catalyst to 400 to 650° C. by oxyhydrogen flame, flowing hydrocarbon gas into the inside of the reformation column, and contacting hydrocarbon gas with the heated catalyst, and hydrogen is obtained by cooling the above-described hydrogen.

Further, the present invention is an apparatus for reforming hydrocarbon gas in which a carbon precipitate tank is arranged by connecting below the reformation column where a catalyst is accommodated, the carbon attached on the catalyst at reformation is shaken off straight down by vibrating the catalyst with a vibrating dust remover provided on the reformation column and scrubbing the catalysts together, the carbon is recovered and, at the same time, the catalyst is reproduced.

### BRIEF DESCRIPTION OF THE DRAWING

FIG. 1 is a vertical section of the hydrocarbon gas reformation column in the present invention.

### DESCRIPTION OF THE PREFERRED EMBODIMENTS

The present invention is to continuously produce a large amount of hydrogen without forming carbon dioxide as a by-product by lowering the decomposition temperature and increasing heat efficiency by performing a thermal decomposition of hydrocarbon gas with a new method and using a new catalyst.

In the present invention, the thermal decomposition of the hydrocarbon gas is performed by directly blowing oxyhydrogen flame into the reformation column sufficiently attached with an insulation apparatus and by rapidly heating the hydrocarbon gas with strong heat generated from the oxyhydrogen flame, active oxygen in over-heated vapor generated from the oxyhydrogen flame has an effect of pulling out hydrogen from carbon in the hydrocarbon gas, the decomposition temperature of the hydrocarbon gas is lowered to 400 to 650° C. with the effect of a catalyst of nickel, platinum, palladium, and carbon, and the thermal yield of the reformation column shows that this thermal decomposition method is industrially effective.

That is, this is because the amount of produced hydrogen is overwhelmingly larger than hydrogen used for heating.

The present invention is a method for reforming hydrocarbon gas by oxyhydrogen flame in which hydrogen and carbon are separated from hydrocarbon gas by accommodating a catalyst 4 composed of nickel, platinum, palladium, and carbon in a reformation column 3 surrounded with insulation, directly heating the catalyst 4 to 400 to 650° C. by oxyhydrogen flame, flowing hydrocarbon gas into the inside of the reformation column 3, and contacting hydrocarbon gas with the heated catalyst 4, and hydrogen is obtained by cooling the above-described hydrogen.

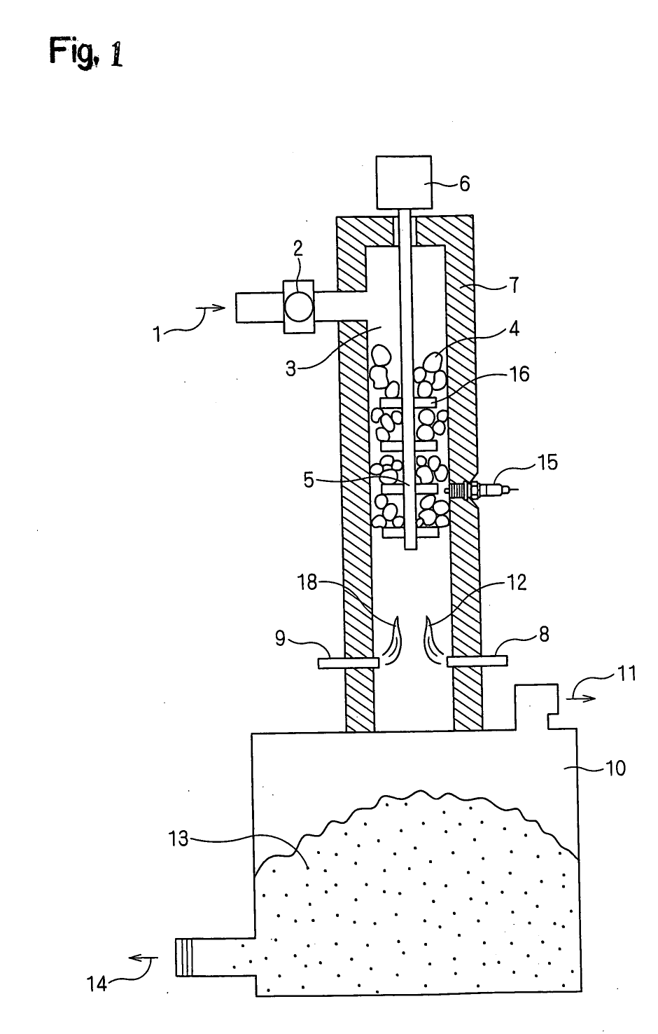

FIG. 1 is the hydrocarbon gas reformation column.

The hydrocarbon gas reformation column consists of the reformation column 3 arranged in the center part of the apparatus, a insulation layer 7 surrounding the reformation column 3, and many layers of a reflecting plate for prevention of radiant heat, the pressure of the air between the reflection plates is reduced, and a carbon precipitate tank 10 is connected to below the reformation column 3.

Further, the present invention is an apparatus for reforming hydrocarbon gas in which the carbon precipitate tank 10 is arranged by connecting below the reformation column 3 where the catalyst 4 is accommodated, the carbon attached on the catalyst 4 at reformation is shaken off straight down by vibrating the catalyst 4 with a vibrating dust remover (a vibration motor 6, a rotation axis 5, and a catalyst shelf 16) provided on the reformation column 3 and scrubbing the catalysts 4 together, the carbon is recovered and, at the same time, the catalyst 4 is reproduced.

The catalyst 4 is filled up on the circular catalyst shelf 16 provided inside of the reformation column 3 and in other spaces. The catalyst shelf 16 is made to slowly rotate in the normal and reverse directions by rotation axis 5 connecting with the vibration motor 6 and giving vibration to the catalyst 4, and the inside is heated to 400 to 650° C.

A mixed material of nickel, platinum, and carbon is used as a catalyst to lower the thermal decomposition temperature, and the amount of sending hydrocarbon gas and the intensity of oxyhydrogen flame are adjusted with an inside column temperature regulator 15 so as to keep the inside of the reformation column at 400 to 650° C.

The reformation column 3 is made of cylindrical metal, the bottom is connected to the carbon precipitate tank 10 accommodating fine powders 13 of carbon, and the entire part has a sealed structure so that the gas inside does not leak to the outside.

The inside of the reformation column 3 is heated to 400 to 650° C. by oxyhydrogen flames 12 and 18 sent from carbon-hydrogen burners 8 and 9 below the reformation column 3.

The hydrocarbon gas is sent in the reformation column 3 through a flow regulator 2 from an inlet 1 in FIG. 1, contacts to the heated catalyst 4, and is heated to 400 to 650° C. Active oxygen in over-heated vapor made by the oxyhydrogen flames 12 and 18 decomposes the hydrocarbon gas at a much lower temperature than the conventional thermal decomposition method and generates hydrogen by performing an action of stripping hydrogen from carbon in the hydrocarbon gas.

The produced hydrogen passes the carbon precipitate tank 10 below, goes through a heat quantity recovering apparatus from an outlet 11, and heads to a hydrogen refining apparatus.

The notation 14 is a carbon takeout port.

The present invention is a method for reforming hydrocarbon gas by oxyhydrogen flame, and the hydrogen produced here can be also used in cogeneration such as air-conditioning and heating using waste heat of the apparatus in addition to using it in a hydrogen gas engine.

The present invention is a method for reforming hydrocarbon gas by oxyhydrogen flame in which hydrogen and carbon are separated from hydrocarbon gas by accommodating a catalyst composed of nickel, platinum, palladium, and carbon in a reformation column surrounded with insulation, directly heating the catalyst to 400 to 650° C. by oxyhydrogen flame, flowing hydrocarbon gas into the inside of the reformation column, and contacting hydrocarbon gas with the heated catalyst, and hydrogen is obtained by cooling the above-described hydrogen; therefore, hydrogen can be reformed, separated, and extracted from a hydrocarbon gas such as methane, ethane, and propane.

Because the present invention is an apparatus of reforming hydrocarbon gas in which a carbon precipitate tank is arranged by connecting it below the reformation column where a catalyst is accommodated, the carbon attached on the catalyst at reformation is shaken off straight down by vibrating the catalyst with a vibrating dust remover provided on the reformation column and scrubbing the catalysts together, the carbon can be recovered and, at the same time, the catalyst can be reproduced.

What is claimed is:

1. A method for reforming hydrocarbon gas by oxyhydrogen flame, wherein hydrogen and carbon are separated from hydrocarbon gas by accommodating a catalyst comprising nickel, platinum, palladium, and carbon in a reformation column surrounded with insulation, directly heating the catalyst to 400 to 650° C. by oxyhydrogen flame, flowing hydrocarbon gas into the inside of the reformation column, and contacting hydrocarbon gas with the heated catalyst, and hydrogen is obtained by cooling the hydrogen.

2. An apparatus for reforming hydrocarbon gas, wherein a carbon precipitate tank is arranged by connecting below the reformation column where a catalyst is accommodated, the carbon attached on the catalyst at reformation is shaken off straight down by vibrating the catalyst with a vibrating dust remover provided on the reformation column and scrubbing the catalysts together, the carbon is recovered and, at the same time, the catalyst is reproducing.
